(19) United States
(12) Patent Application Publication
(10) Pub. No.: US 2013/0259613 A1
(43) Pub. Date: Oct. 3, 2013

(54) Bulk Material Loading Arrangement

(71) Applicant: Timothy John Fleischer, Port Elizabeth (ZA)

(72) Inventor: Timothy John Fleischer, Port Elizabeth (ZA)

(73) Assignee: BULK BOX LOGISTICS (PTY) LIMITED, Port Elizabeth (ZA)

(21) Appl. No.: 13/879,200

(22) PCT Filed: Oct. 12, 2011
(86) PCT No.: PCT/IB2011/054497

§ 371 Date: Jun. 11, 2013

(30) Foreign Application Priority Data
Oct. 12, 2010 (ZA) 2010/07290

(51) Int. Cl. B65G 67/04

(52) U.S. Cl. CPC B65G 67/04
USPC 414/373; 414/401

(57) ABSTRACT

Disclosed is a loading station and method that allows for simultaneous loading of a plurality of railway carriages. The loading station includes a length of railway for receiving the railway carriage, and an overhead displacement configuration suitable for displacing a bottom discharge container, containing the bulk material to be discharged into the railway carriage, relative to the railway. The loading station also includes an actuation means for allowing a bottom discharge door of the bottom discharge container to be (a) retained in a closed position when the bottom discharge container is offset relative to the railway carriage, and (b) displaced to the open position when the bottom discharge container is aligned with the railway carriage so as to allow the load inside the bottom discharge container to be loaded directly into the railway carriage.

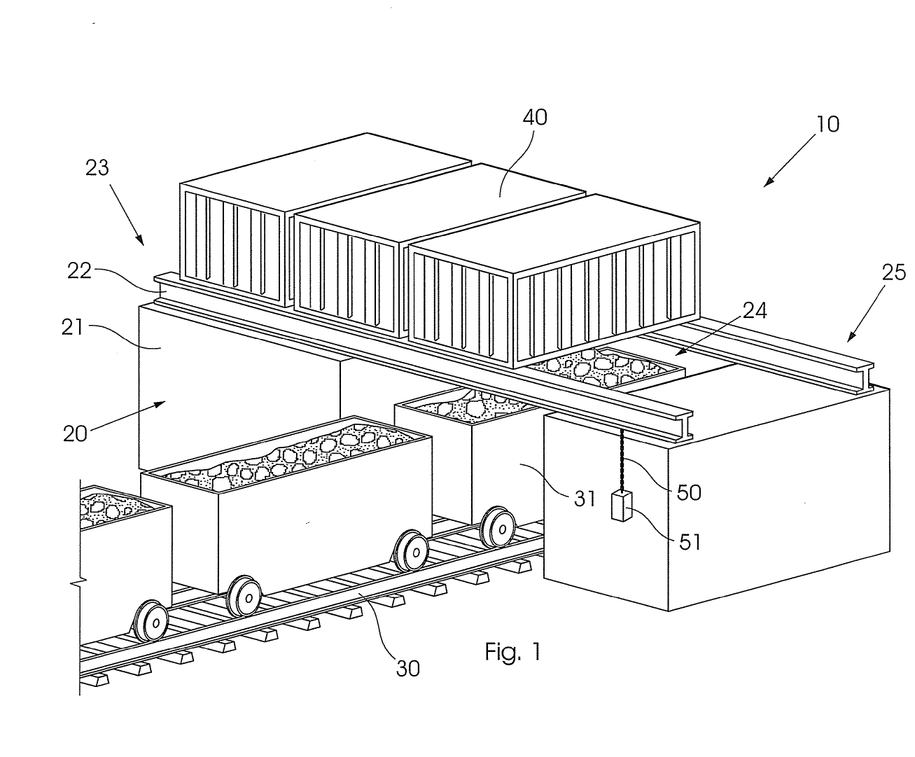

### BACKGROUND TO THE INVENTION

THIS invention relates to a loading station and method for the loading of bulk materials into rail carriages. More particularly, but not exclusively, the invention relates to a loading station and method that allows for simultaneous loading of a plurality of railway carriages.

The handling and transportation of bulk material is a process that is ubiquitous in trade and industry. A popular mode of transportation of bulk material is rail transportation. There are however a number of shortcomings that are associated with the existing rail transportation approach, in particular insofar as the transportation of bulk materials is concerned.

Bulk materials, such as coal and ore, are typically transported in purpose built railroad cars, including hopper cars and rotary car dumpers. The loading of the bulk material into the cars is however a factor that influences the efficiency and economic viability of rail transport of bulk materials. Typically, bulk cargo is dropped or poured into a suitable railroad car using a spout or shovel bucket. It will however be appreciated that this is effectively a batch process in which the railroad cars are loaded sequentially. This result in the process of loading the carriages being a time-consuming one, which renders the process inefficient. It also results in sub-optimal utilization of locomotives due to extended standing times. In addition, the capacity of hoppers used when loading the carriages with spouts are limited—sometimes to the extent that they need to be replenished during a loading operation.

It is accordingly an object of the invention to provide a loading station and method for the loading of bulk materials that will, at least partially, alleviate the above disadvantages.

It is also an object of the invention to provide a bulk material loading station which will be a useful alternative to existing sequential loading arrangements.

### SUMMARY OF THE INVENTION

According to a first aspect of the invention there is provided a loading station for use in the loading of bulk materials into railway carriages suitable for receiving the bulk material, the loading station including:
a length of railway for receiving the railway carriage;
an overhead displacement configuration suitable for displacing a bottom discharge container, containing the bulk material to be discharged into the railway carriage, relative to the railway; and
actuation means for allowing a bottom discharge door of the bottom discharge container to be retained in a closed position when the bottom discharge container is offset relative to the railway carriage, and allowing the bottom discharge door of the bottom discharge container to be displaced to the open position when the bottom discharge container is aligned with the railway carriage so as to allow the load inside the bottom discharge container to be loaded directly into the railway carriage.

There is provided for the actuating means to include a displaceable release mechanism being displaceable between a first position, in which the release mechanism is adapted to retain the bottom discharge door of the bottom discharge container in a closed position, and a second position in which the bottom discharge door is allowed to be displaced to the open position.

In one embodiment there is provided for the release mechanism to be in the form of a chain that is displaceable between the first position, in which it is taut and therefore abutting the discharge door of the bottom discharge container, and a second position, in which it is slack and therefore allows the door to open under gravitational bias.

There is provided for the chain to be displaceable between the first and second positions by way of a piston and cylinder assembly.

The overhead displacement configuration is preferably in the form of an inclined bridge structure, which allows the bottom discharge container to be slideably displaceable from a first end of the bridge structure towards a second end of the bridge structure.

There is provided for the overhead displacement configuration to be configured for receiving a plurality of bottom discharge containers adjacent one another, so as to enable preloading of bottom discharge containers onto the loading station.

According to a second aspect of the invention there is provided a loading station for use in the loading of bulk materials into railway carriages suitable for receiving the bulk material, the loading station including:
a length of railway for receiving a plurality of railway carriages;
an overhead loading configuration comprising a plurality of loading stations for simultaneous loading of at least some of the plurality of railway carriages;
each loading station including a bottom discharging container arrangement that can be preloaded with the bulk materials.

### DESCRIPTION OF AN EMBODIMENT OF THE INVENTION

A non-limiting example of one embodiment of the invention is described with reference to the accompanying figure, which is a schematic perspective representation of a loading station in accordance with the invention.

The loading station 10 comprises a length of railway 30, suitable for receiving railway carriages 31 adapted to receive a bulk material to be transported, and an overhead displacement arrangement 20 for receiving bottom discharge containers 40 to be discharged into the railway carriages. The overhead displacement arrangement is configured to allow for the containers 40 to be displaceable 31 transversely relative to the railway 30.

In this embodiment, the overhead displacement arrangement is in the form of two substantially parallel, spaced apart beams 22, which are supported by suitable support structures 21 so as to define a displacement arrangement that bridges the railway 30. The beams 22 and/or the support structures 21 are provided with rollers (not shown) on operatively upper faces thereof, so as to enable the bottom discharge containers 40 to be slideably displaceable from a first end 23 of the displacement arrangement towards a bridging section 24 of the displacement arrangement where the container will be discharged, and from there towards a second end 25 of the displacement arrangement, from where the empty bottom discharge container can be removed.

When a bottom discharge container 40 initially arrives at the bridging section 24 and is aligned with a railway carriage 31 ready to receive a load, a bottom discharge door (not shown) of the bottom discharge container is kept in a closed position by way of an actuation means 50, for example in the form of a displaceable chain, which is at this time retained in a taut condition by way of a piston and cylinder arrangement 51. When loading of the railway carriage is required, the piston and cylinder arrangement 51 is actuated, thus resulting in the chain being displaced to a slack condition, which allows the bottom discharge door of the bottom discharge container to open under gravity. Once the bottom discharge container has been emptied, the chain is returned to the taut condition—thus closing the door of the bottom discharge container. The container can now be displaced to the second end of the overhead displacement arrangement, from where it can be picked up for refilling. It will be appreciated that, although in this example specific reference is made to a chain system, varies other mechanisms can be employed, provided that they allow for the bottom discharge door of the container to be selectively retained in the closed position, or allowed to be displaced to the open position. Displacement to the open position will generally be under gravitational bias, but it is also foreseeable that mechanically induced displacement may be utilised.

Although not shown in the drawing, an important aspect of this invention is that a plurality of these loading stations 10 will be located adjacent one another, which will enable simultaneous loading of a plurality of rail carriages, and will thus negate the need for time consuming and inefficient sequential loading. There may be other ways in which this concept can be implemented, and the above example illustrates but one embodiment.

In addition, the overhead displacement arrangement is adapted to receive a plurality of loaded bottom discharge containers, thus allowing the loading station to be preloaded, which further reduces operational down time and wastage.

It will be appreciated that the above is only one embodiment of the invention, and that there may be many variations without departing from the spirit and/or the scope of the invention.

1-9. (canceled)

10. A loading station for use in the loading of bulk materials into railway carriages suitable for receiving the bulk material, the loading station comprising:
a length of railway for receiving the railway carriage;
an overhead displacement configuration suitable for displacing a bottom discharge container, containing the bulk material to be discharged into the railway carriage, relative to the railway; and
actuation means for allowing a bottom discharge door of the bottom discharge container to be retained in a closed position when the bottom discharge container is offset relative to the railway carriage, and allowing the bottom discharge door of the bottom discharge container to be displaced to the open position when the bottom discharge container is aligned with the railway carriage so as to allow the load inside the bottom discharge container to be loaded directly into the railway carriage.

11. The loading station of claim 10, wherein the actuation means includes a displaceable release mechanism displaceable between a first position, in which the release mechanism is adapted to retain the bottom discharge door of the bottom discharge container in a closed position, and a second position in which the bottom discharge door is allowed to be displaced to the open position.

12. The loading station of claim 11, wherein the release mechanism is in the form of a chain that is displaceable between the first position, in which it is taut and therefore abutting the discharge door of the bottom discharge container, and a second position, in which it is slack and therefore allows the door to open under gravitational bias.

13. The loading station of claim 12, wherein the chain is displaceable between the first and second positions by way of a piston and cylinder assembly.

14. The loading station of claim 10, wherein the overhead displacement configuration is in the form of an inclined bridge structure, which allows the bottom discharge container to be slideably displaceable from a first end of the bridge structure towards a second end of the bridge structure.

15. The loading station of claim 14, wherein the overhead displacement configuration is configured to receive a plurality of bottom discharge containers adjacent one another, so as to enable preloading of bottom discharge containers onto the loading station.

16. The loading station of claim 10 substantially as described with reference to the accompanying figure.

17. A loading arrangement for use in the loading of bulk materials into railway carriages suitable for receiving the bulk material, the loading arrangement comprising:
a length of railway for receiving a plurality of railway carriages; and
an overhead loading configuration comprising a plurality of loading stations for simultaneous loading of at least some of the plurality of railway carriages;
wherein each loading station includes a bottom discharging container arrangement that can be preloaded with the bulk materials.

18. The loading arrangement of claim 17, wherein the loading stations each include:
an overhead displacement configuration suitable for displacing a bottom discharge container, containing the bulk material to be discharged into the railway carriage, relative to the railway; and
actuation means for allowing a bottom discharge door of the bottom discharge container to be retained in a closed position when the bottom discharge container is offset relative to the railway carriage, and allowing the bottom discharge door of the bottom discharge container to be displaced to the open position when the bottom discharge container is aligned with the railway carriage so as to allow the load inside the bottom discharge container to be loaded directly into the railway carriage.
